(19) United States
(12) Patent Application Publication
(10) Pub. No.: US 2026/0094445 A1
(43) Pub. Date: Apr. 2, 2026

(54) SYSTEM AND METHOD FOR 3D OBJECT DETECTION BY AN AUTONOMOUS VEHICLE IN ADVERSE ENVIRONMENTAL CONDITIONS USING MULTIMODAL FUSION

(71) Applicant: Torc Robotics, Inc., Blacksburg, VA (US)

(72) Inventors: Edoardo Palladin, Stuttgart (DE); Praveen Narayanan, Montreal (CA); Mario Bijelic, Frankfurt (DE); Felix Heide, New York, NY (US); Roland Paul Dietze, Stuttgart (DE)

(21) Appl. No.: 18/902,283

(22) Filed: Sep. 30, 2024

(51) Int. Cl. G06V 20/52; B60W 60/00; G06T 7/50; G06V 10/44; G06V 10/80

(52) U.S. Cl. CPC G06V 20/52; B60W 60/001; G06T 7/50; G06V 10/44; G06V 10/806; G06V 2201/07

(57) ABSTRACT

An autonomy computing system of an autonomous vehicle for object detection in adverse environmental conditions is provided. The at least one processor of the autonomy computing system is programmed to receive sensor data from one or more sensors of a plurality of modalities, the second sensor data being in a bird's eye view (BEV). The at least one processor is further programmed to extract first features and second features in the environment, and to fuse, in the BEV, the first features and the second features into first enriched features and second enriched features. The at least one processor is also programmed to detect object proposals based on the first enriched features and the second enriched features, predict objects in the environment based on the object proposals, and control operation of the autonomous vehicle based on predicted objects.

### STATEMENT REGARDING FEDERALLY SPONSORED RESEARCH & DEVELOPMENT

This invention was made with government support under NSF Career Award (2047359) awarded by the National Science Foundation. The government has certain rights in the invention.

### TECHNICAL FIELD

The field of the disclosure relates generally to autonomous vehicles and, more specifically, to object detection by an autonomous vehicle.

### BACKGROUND OF THE INVENTION

An autonomous vehicle relies on multi-modal perception systems to detect objects in the environment, in which the autonomous vehicle is operating. The detected objects are used in controlling operation of the autonomous vehicle. Sensor data from multiple modalities may be fused for detecting objects. In a clear weather condition, performance in fusion of the sensor data and object detection may be satisfactory. However, in adverse environmental conditions, fusion and detection may be less than satisfactory because sensors and/or sensor data of one or two modalities may be compromised under the adverse environmental conditions. Accordingly, it is desirable to provide systems and methods for improved object detection in adverse environmental conditions.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system of an autonomous vehicle for object detection by the autonomous vehicle in adverse environmental conditions is provided. The autonomy computing system includes at least one processor in communication with at least one memory device. The at least one processor is programmed to receive sensor data of an environment in which the autonomous vehicle is operating. The sensor data are detected from one or more sensors of a plurality of modalities, the plurality of modalities including a first modality and a second modality, the sensor data including first sensor data from one or more sensors of the first modality and second sensor data from one or more sensors of the second modality, the second sensor data being in a bird's eye view (BEV). The at least one processor is further programmed to extract first features in the environment based on the first sensor data and second features in the environment based on the second sensor data. The at least one processor is also programmed to fuse, in the BEV, the first features and the second features into first enriched features of the first modality and second enriched features of the second modality by representing the first features in the BEV to derive first BEV features, based on depth information of the first features, fusing the first features with the second features corresponding to the first BEV features to derive the first enriched features, and fusing the second features with the first features corresponding to the second features to derive the second enriched features. In addition, the at least one processor is programmed to detect object proposals based on the first enriched features and the second enriched features, predict objects in the environment based on the object proposals, and control operation of the autonomous vehicle based on predicted objects.

In another aspect, a method for object detection by an autonomous vehicle in adverse environmental conditions is provided. The method includes receiving sensor data of an environment in which the autonomous vehicle is operating. The sensor data are detected from one or more sensors of a plurality of modalities, the plurality of modalities including a first modality and a second modality, the sensor data including first sensor data from one or more sensors of the first modality and second sensor data from one or more sensors of the second modality, the second sensor data being in a BEV. The method further includes extracting first features in the environment based on the first sensor data and second features in the environment based on the second sensor data. The method also includes fusing, in the BEV, the first features and the second features into first enriched features of the first modality and second enriched features of the second modality by representing the first features in the BEV to derive first BEV features, based on depth information of the first features, fusing the first features with the second features corresponding to the first BEV features to derive the first enriched features, and fusing the second features with the first features corresponding to the second features to derive the second enriched features. In addition, the method includes detecting object proposals based on the first enriched features and the second enriched features, predicting objects in the environment based on the object proposals, and controlling operation of the autonomous vehicle based on predicted objects.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle.

FIG. 2 is a block diagram of an autonomous vehicle.

FIG. 3 is a flow chart of an example method for object detection.

FIG. 4A is a schematic diagram of a neural network model.

FIG. 4B is a schematic diagram of a neuron in the neural network model shown in FIG. 4A.

FIG. 5 is a block diagram of an example computing device.

FIG. 6 illustrates an example sensor-adaptive multi-modal fusion (SAMFsuion) used for object detection.

FIGS. 7A-7C show SAMFusion architecture.

FIGS. 8A and 8B show measurements of the individual method performance on the most difficult class of pedestrians.

FIG. 9 is a table showing evaluation of SAMFusion's detection performance measured in average precision (AP) and compared to state-of-the-art mono- and multi-modal methods based on the car and pedestrian classes on publicly available test dataset Seeing ThroughFog.

FIG. 10 shows qualitative results on three dimensional (3D) object detection in adverse weather compared to state-of-the-art multi-modal sensor fusion methods and ground truth (GT).

FIG. 11 shows qualitative results of the method described herein and known approaches (in columns).

FIG. 12 is a table showing performance of SAMFusion measured in AP compared to known multimodal methods in challenging weather conditions, evaluated on the car and pedestrian classes.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods of object detection based on multi-modal fusion are provided. Because operation of an autonomous vehicle relies on objects detected in the environment around the autonomous vehicle, the quality of object detection needs to be closely controlled. In at least some known methods of object detection, sensor data from one or two modalities are used for object detection. The features are fused in 2D. A 2D fusion is unsatisfactory because sensor data from some modalities are in 2D while sensor data from other modalities are in 3D or a bird's eye view (BEV). A 2D fusion, therefore, may introduce errors or inaccuracies in fusing features from different modalities. Further, one or more sensors of one or more modalities may be compromised or fail, especially in adverse environmental conditions, such as at night or twilight, in a rainy, snowy, and/or foggy weather, and/or having obstructions from soiling. As used herein, adverse environmental conditions refer to conditions of the environment in which the autonomous vehicle travels that may compromise the performance of one or more sensors and/or quality of sensor data of the sensor(s). In clear environmental conditions, 2D fusion of one or two modalities may provide satisfactory performance for object detection. However, in adverse environmental conditions, at least some known methods may fail in object detection. In one known method, after features are extracted from sensor data, random initial proposals are used as initial proposals for a transformer decoder in detecting object proposals in the features. Because random initial proposals do not include any information from the features, the full potential in the extracted features is not realized in detecting object proposals based on the extracted features.

In contrast, the systems and methods described herein address the above-described problems in known methods. Two or more modalities are used in feature extraction and detection of object proposals. Using three or more modalities in fusion and object detection increases the accuracy of object detection. A 3D fusion is employed in the systems and methods, where extracted features from different modalities are represented in the BEV before the features are fused, thereby increasing the accuracy of fusion by including the depth information of the features in fusion. The extracted features are enriched by fusing the features from multiple modalities. Cross-modal attention and/or intra-modal attention may be used to further enhance the quality of fusion. After features are extracted and enriched, initial proposals are used in detecting object proposals with a transformer decoder, where the initial proposals are based on fused enriched features. Fused enriched features are performed in the BEV, thereby increasing the quality in fusing enriched features. Enriched features may be distance-weighted to account for the differences in ranges by different modalities. As a result, the fused enriched features include features from different modalities and are weighted according to the detection capabilities of the different modalities. Using initial proposals based on fused enriched features are advantageous in increasing the accuracy and detection distance in object detection, fully realizing the potential of all of the modalities. The robustness in object detection with systems and methods described herein are increased because object detection is based on fused features where different modalities complement one another, the features from different modalities are fused with increased accuracy, and features from different modalities are weighted in fusion based on performance of individual modalities under the environmental conditions and/or at certain distances. Systems and methods described herein significantly increase performance in detecting pedestrians in the environment. Compared to vehicles, pedestrians are relatively difficult to detect, especially in adverse environmental conditions, because pedestrians are smaller than vehicles and available datasets for training a machine learning model tend to have less data on pedestrians than vehicles. One or more gated cameras may be used to increase the accuracy and robustness in detecting pedestrians because a gated camera is advantageous in gathering data points from a pedestrian in adverse environmental conditions with increased signal-to-noise ratios (SNRs), especially at night or twilight. The models in the systems and methods learn to adjust for different adverse environmental conditions in fusing and weighting features, without the need of making changes or adjustments to the design of the models, training data, or training of the models to cater to specific adverse environmental conditions, thereby increasing the robustness and flexibility of the systems and methods.

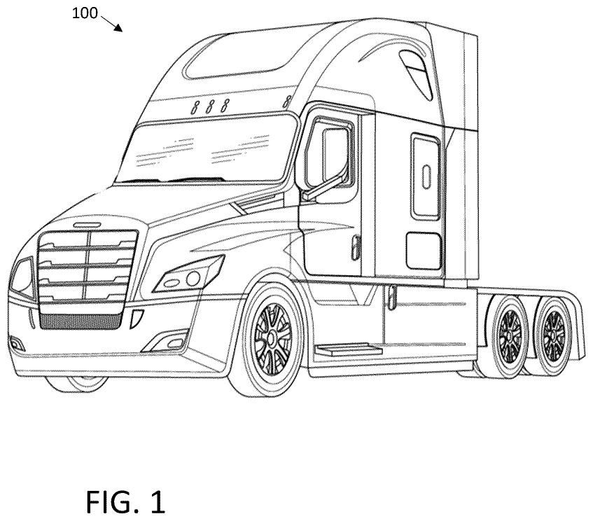

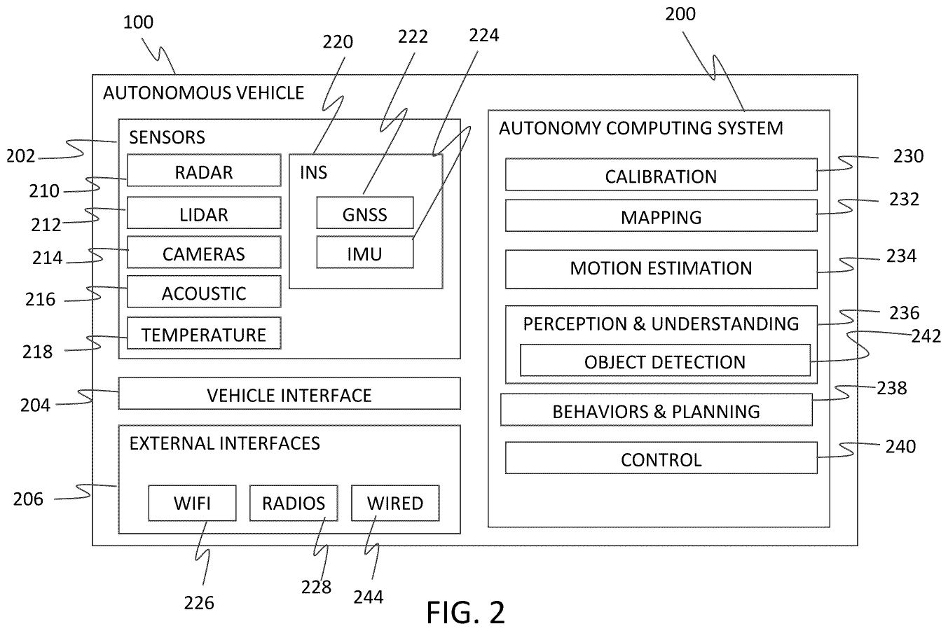

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 may include RGB cameras, which are configured to capture images based on visible light. Cameras 214 may further include a gated camera, such as gated near infrared (NIR) camera. A gated camera is configured to capture images based on invisible light, such as NIR light. Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an object detection module 242. Object detection module 242, for example, may be embodied within another module, such as perception & understanding module 236, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Object detection module 242 is configured to detect objects in the environment surrounding autonomous vehicle 100. In object detection modules 242, features are extracted based on sensor data from one or more sensors of two or more modalities. The features from different modalities are fused in the BEV to derive enriched features. The enriched features from two or more modalities may be fused and/or weighted to generate initial object proposals to a transformer decoder in detecting object proposals based on the enriched features. Objects in the environment are detected based on the object proposals.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

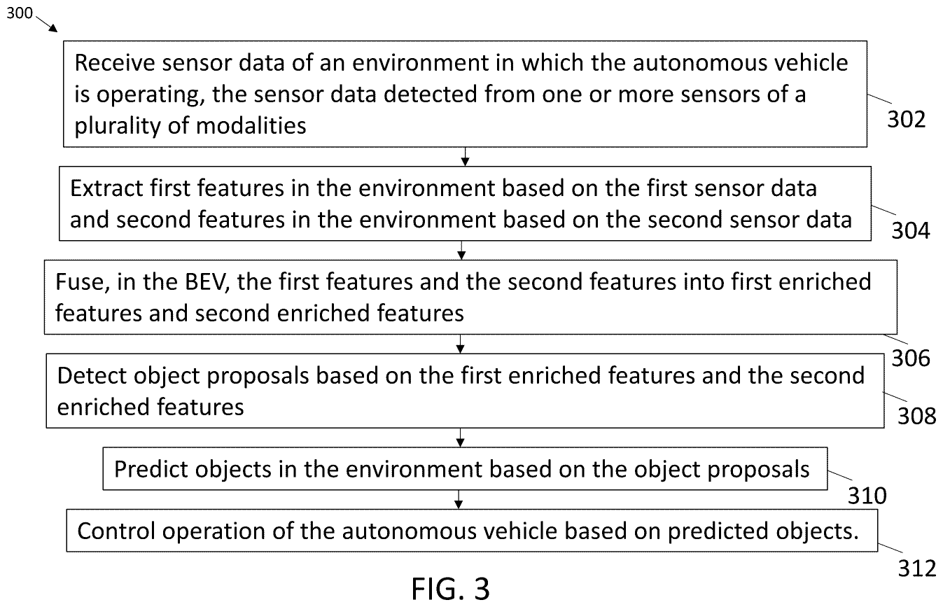

FIG. 3 is flow chart of an example method 300 for object detection by an autonomous vehicle. Method 300 may be implemented in object detection module 242. In the example embodiment, method 300 includes receiving 302 sensor data of an environment in which the autonomous vehicle is operating. The sensor data are detected from one or more sensors of a plurality of modalities. The plurality of modalities include a first modality and a second modality. The sensor data include first sensor data from one or more sensors of the first modality and second sensor data from one or more sensors of the second modality. The second sensor data are in the BEV. For example, the first modality is a gated camera, such as a gated NIR camera, and the second modality is LiDAR. The first sensor data are image data detected by the gated camera. The second sensor data are LiDAR data detected by LiDAR sensors. In some embodiments, the number of modalities may be three or more. Sensor data from at least one of the plurality of modalities, such as the second modality, are represented in the BEV.

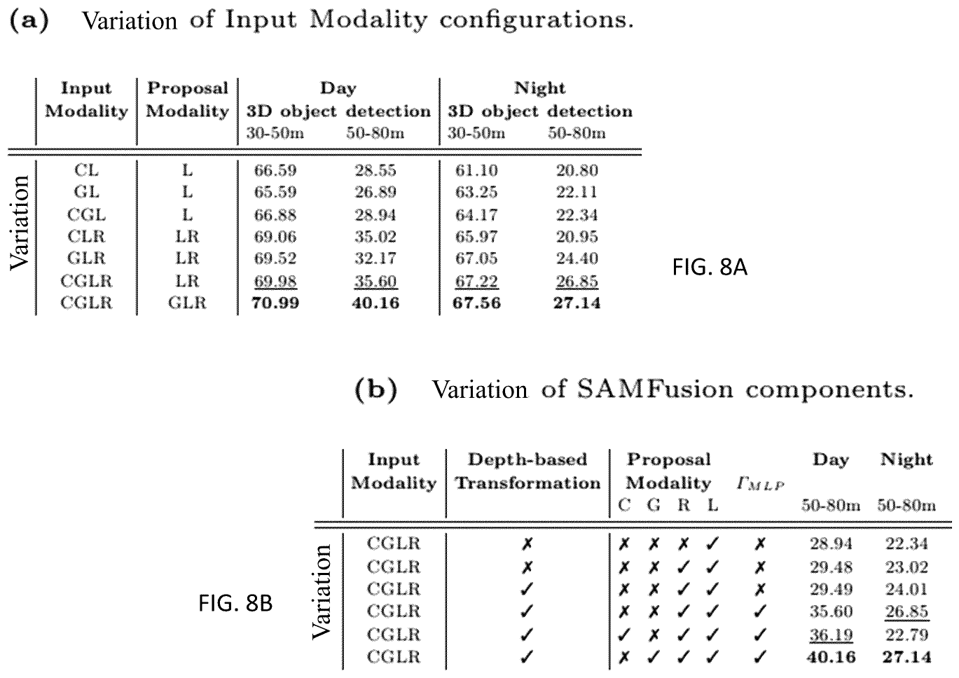

In at least some known methods, one or two modalities are used. The accuracy of detection is satisfactory when the environmental condition is clear, but is significantly reduced in adverse environmental conditions. In contrast, an increased number of modalities as used in systems and methods described herein is advantageous in improving object detection because sensors of different modalities tend to complement one another for detecting objects. Especially in adverse environmental conditions, where certain modalities may be compromised. For example, in rainy weather, LiDAR is compromised, or at night or twilight, RGB cameras are compromised. Modalities, such as a gated camera or radar sensors, are less affected by environmental conditions. As shown in FIG. 8A (described later in further detail), the increased number of modalities for input sensor data increases the accuracy of detection, where C refers to RGB cameras, L refers to LiDAR, G refers to a gated camera, and R refers to radar. Detection with four modalities performs better than with two or three modalities, and detection with three modalities perform better with two modalities.

In the example embodiments, method 300 includes extracting 304 features in the environment in which the autonomous vehicle is operating, based on the sensor data. For example, first features in the environment is extracted based on the first sensor data, and second features in the environment is extracted based on the second sensor data. Features may be extracted for each of the plurality of modalities. A neural network model may be used to extract features in the environment. An example neural network model may be a residual network (ResNet), a convolutional neural network (CNN), or a model designed to detect features from point clouds, such as for LiDAR and/or radar data. A separate neural network model may be used to extract features for individual modalities. In some embodiments, the same neural network model is used to extract features for two or more modalities.

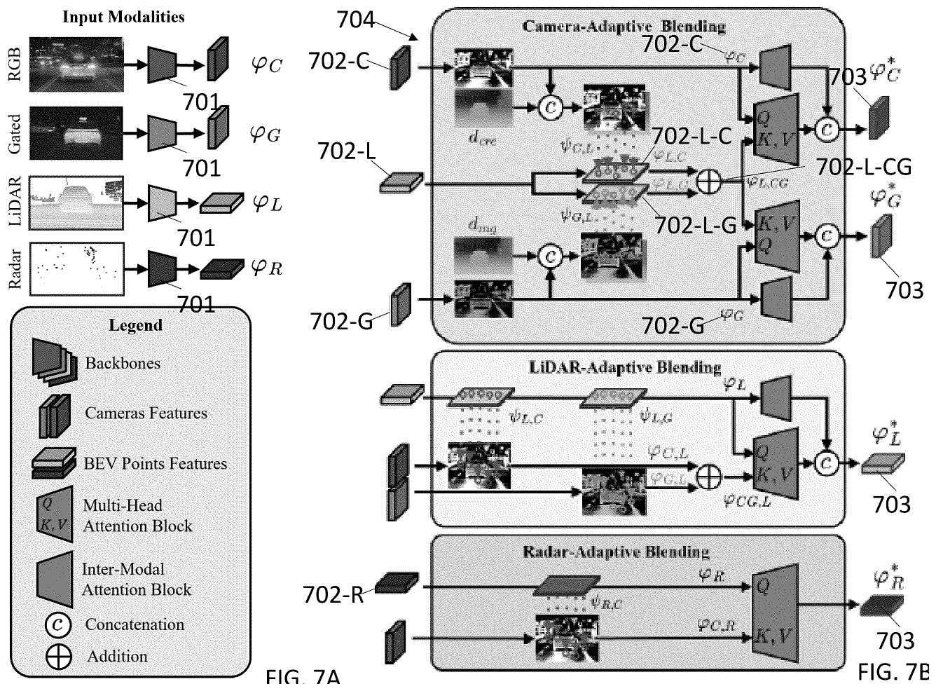

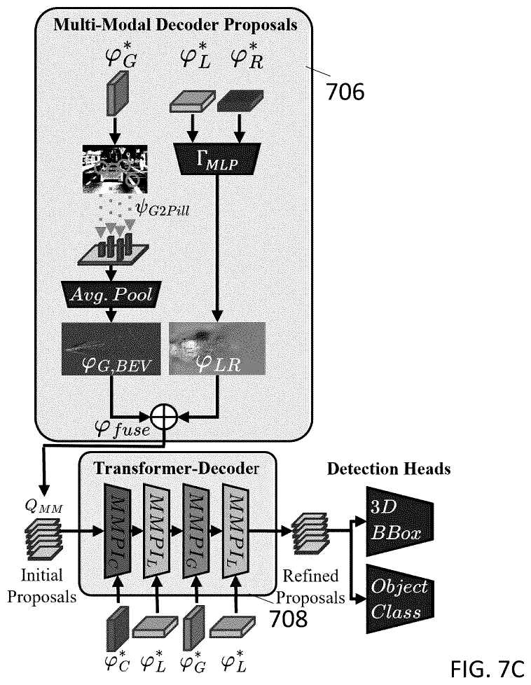

In the example embodiments, method 300 includes fusing 306 in the BEV the features into enriched features corresponding to individual modalities. For example, the first features and the second features are fused in the BEV into first enriched features corresponding to the first modality and second enriched features corresponding to the second modality. The fusion is performed in the BEV. Features of a modality that is not represented in the BEV is represented in the BEV using depth information based on the sensor data, before fusing with features represented in the BEV. Fusing in the BEV is advantageous in increasing accuracy of object detection, because features will be represented in the same coordinate system and include the depth information. Referring to FIG. 7B (described later in further detail), features 702-C in sensor data from RGB cameras or features 702-G in sensor data from a gated camera are in 2D, while features 702-L in sensor data from LiDAR or features 702-R in sensor data from radar data are represented in the BEV. Before fusing features 702-C, 702-G with features 702-L, features 702-C, 702-G are transformed into the LiDAR coordinate system. Depth of each pixel in the features 702-C, 702-G is derived before transforming features 702-C, 702-G to be represented in the BEV. Depth of features 702-C of RGB cameras may be derived based on two or more cameras, or stereo cameras. Depth of features 702-G may be derived based on the acquisition mechanism of a gated camera, where the depth information is embedded in the sensor data. In acquiring a picture, a gated camera is gated at a certain point of time or time of flight, and therefore the time of flight is directly related to the depth of the picture. The depth information of features 702-G may be obtained via a machine learning model trained to determine a depth of an image. The machine learning model may be pretrained. With the depth information, pixels in the features 702 are lifted into a 3D point cloud and a change of frame of reference is applied to bring the 3D points into the LiDAR coordinate frame. The 3D points of features for the RGB or gated camera(s) are squashed along the height coordinate onto the BEV grid of the LiDAR.

In the example embodiments, the plurality of modalities includes a first camera modality and a second camera modality. First camera features are extracted based on sensor data from one or more sensors of the first camera modality. Second camera features are extracted based on sensor data from one or more sensors of the second camera modality. The second features corresponding to first BEV camera features and the second features corresponding to second BEV camera features are blended to derive composite paired second features, the first BEV camera features being the first camera features represented in the BEV, the second BEV camera features being the second camera features represented in the BEV. The composite paired second features are fused with the first camera features to derive first enriched camera features. The composite paired second features are fused with the second camera features to derive second enriched camera features (see Camera-Adaptive Blending in FIG. 7B). For example, after the features for the RGB or gated camera(s) are represented in the same BEV coordinate system as the LiDAR, features 702-L in LiDAR are paired with features from camera(s) represented in the BEV (or referred to as BEV camera features), resulting in LiDAR features 702-L-C paired with RGB cameras or LiDAR features 702-L-G paired with the gated camera. The paired LiDAR features 702-L-C, 702-L-G may be blended to get composite paired LiDAR features 702-L-CG. Using composite paired LiDAR features is advantageous in integrating details detected by different camera modalities and avoiding the situation when either modality, RGB cameras or the gated camera, fails. The composite paired LiDAR features are fused with camera features to derive enriched camera features.

In the example embodiments, camera features of individual camera modalities may be paired with features of a non-camera modality separately and the paired camera features from individual camera modalities may be blended to derive composite camera features. The features of the non-camera modality are fused with the composite paired camera features to derive enriched features of the non-camera modality (see LiDAR-Adaptive Blending in FIG. 7B).

In the example embodiments, attention is used in aligning paired feature points in LiDAR with feature points in the camera(s), where LiDAR features are weighted with attention for fusing with features of camera(s). In machine learning, attention determines the relative importance of a component in a sequence relative to other components in that sequence. Cross-modal attention may be used, where feature points between different modalities are weighted through attention. For example, the paired LiDAR features as keys are queried with features in camera(s), RGB cameras or the gated camera, resulting in enriched aligned features. In some embodiments, intra-modal attention may also be included, where feature points of a modality are weighted relative to neighbor points of the feature points. Attention increases the performance of fusing 306 the features. The aligned features with attention from LiDAR are fused with features in camera(s) to derive enriched features for camera(s) or enriched camera features.

In the example embodiments, features of a modality may be fused with features from one or more other modalities in deriving enriched features 703 of that modality. Fusion depicted in FIG. 7B is an example for illustration purposes only. Other combination of modalities may be implemented to enable the systems and methods to function as described herein. For example, features from radar may be fused with features from the gated camera.

Referring back to FIG. 3, in the example embodiments, method 300 further includes detecting 308 object proposals based on the enriched features. For example, object proposals are detected based on the first enriched features corresponding to the first modality and the second enriched features corresponding to the second modality. In some embodiments, enriched features from three or more modalities are used to detect object proposals.

In the example embodiments, in detecting object proposals, initial proposals may be generated and used as initial proposals for the final detected object proposals. In at least one known method, object proposals are detected based on features using a transformer decoder with random initial proposals, which may bear no relation with the environment. In contrast, systems and methods described herein generate initial proposals based on the enriched features, thereby increasing the convergence speed and performance in object detection.

Referring to FIG. 7C (describer later in further detail), in the example embodiments, initial proposals may be generated based on enriched features of the gated camera, LiDAR, and radar. The enriched features for LiDAR and the enriched features for radar are weighted and combined. The weightings used in the combination is distance dependent, because LiDAR has a closer range than radar. The weightings are used to amplify features detected by LiDAR at a relatively close range and suppress features detected by LiDAR at a relatively long range to favor radar. The weighted combined enriched features for LiDAR and radar are fused with enriched features for the gated camera to generate a fused feature map. The enriched features for the gated camera are transformed to be represented in the BEV, referred to as BEV enriched features, before fusing with the weighted combined enriched features for LiDAR and radar, thereby increasing the accuracy in object detection. Initial proposals are extracted based on the fused feature map. The initial proposals depicted in FIG. 7C are described as example for illustration purposes only. Other mechanism of generating initial proposals may be used to enable the systems and methods to function as described herein. For example, enriched features for RGB cameras may be fused with features from LiDAR and radar to generate a fused feature map for initial proposals.

Referring back to FIG. 3, method 300 further includes predicting 310 objects in the environment based on the object proposals. The objects may be classified into classes, such as vehicles or pedestrians. Bounding boxes (bboxes) of the objects may be predicted. In addition, method 300 includes controlling 312 operation of the autonomous vehicle based on the predicted objects. For example, the traveling trajectory of autonomous vehicle 100 may be adjusted in light of the predicted objects, to avoid collision with the objects. The predicted objects may be included in decision making in operation of autonomous vehicle 100. For example, autonomy computing system 200 may determine to merge or not to merge based on the predicted objects. With increased accuracy in object detection, the performance of autonomous vehicle 100 is improved, especially when operating in adverse environmental conditions.

In the example embodiments, one or more machine learning models may be used in method 300. The machine learning model may be a neural network model. Extracting 304, fusing 306, detecting 308, and predicting 310 may be implemented in an overarching machine learning model. An example architecture of the overarching machine learning model is shown in FIGS. 7A-7C. The overarching machine learning model may include one or more sub machine learning models for at least one of processes of extracting 304, fusing 306, detecting 308, and predicting 310 (see FIGS. 7A-7C).

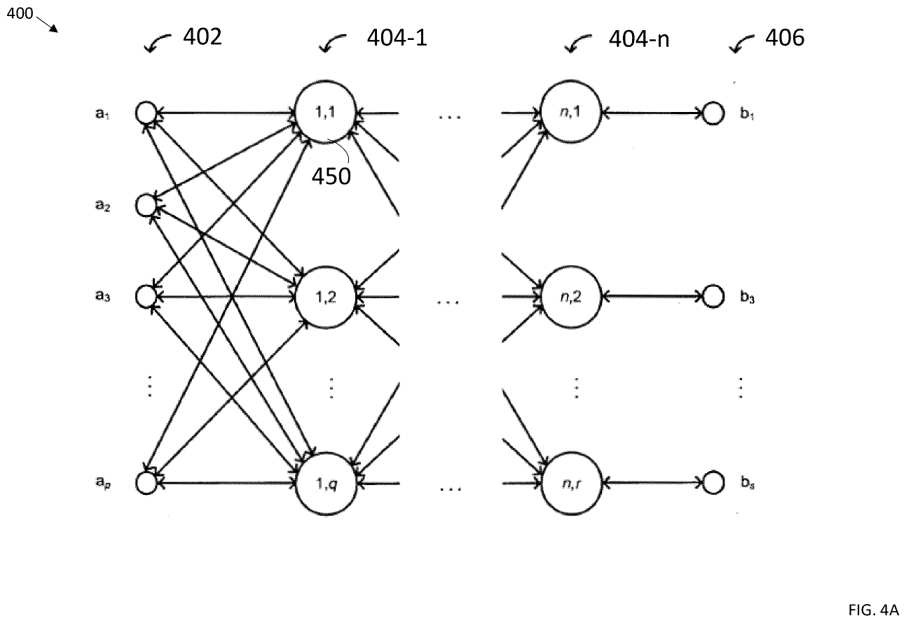

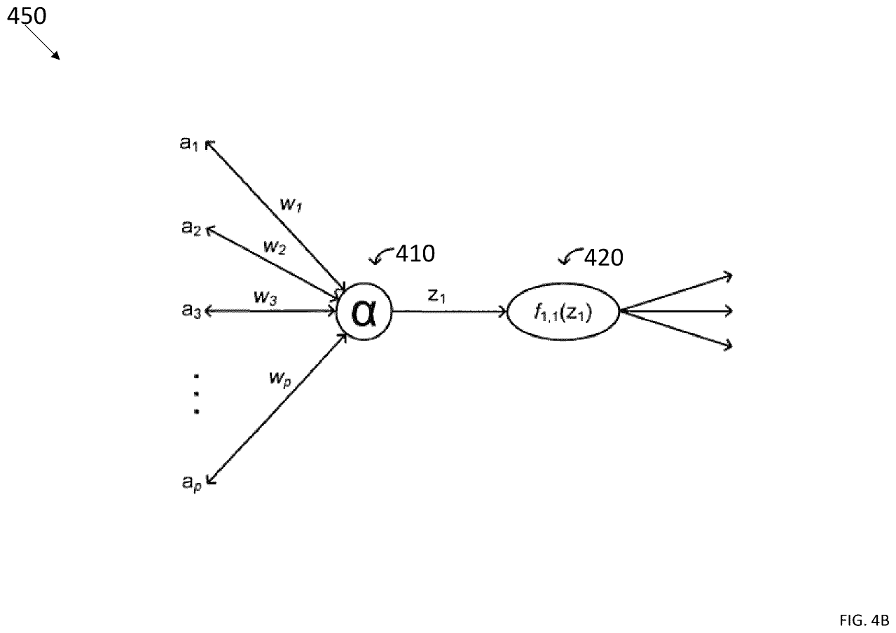

FIG. 4A depicts an example artificial neural network model 400. Method 300 may be implemented with one or more neural network model 400. The architecture depicted in FIGS. 7A-7C may include one or more neural network models 400. The example neural network model 400 includes layers of neurons 450, 404-1 to 404-n, and 406, including an input layer 402, one or more hidden layers 404-1 through 404-n, and an output layer 406. Each layer may include any number of neurons, i.e., q, r, and n in FIG. 4A may be any positive integer. It should be understood that neural networks of a different structure and configuration from that depicted in FIG. 4A may be used to achieve the methods and systems described herein.

In the example embodiment, the input layer 402 may receive different input data. For example, the input layer 402 includes a first input a₁ representing training images, a second input a₂ representing patterns identified in the training images, a third input a₃ representing edges of the training images, and so on. The input layer 402 may include thousands or more inputs. In some embodiments, the number of elements used by the neural network model 400 changes during the training process, and some neurons are bypassed or ignored if, for example, during execution of the neural network, they are determined to be of less relevance.

In the example embodiment, each neuron in hidden layer(s) 404-1 through 404-n processes one or more inputs from the input layer 402, and/or one or more outputs from neurons in one of the previous hidden layers, to generate a decision or output. The output layer 406 includes one or more outputs each indicating a label, confidence factor, weight describing the inputs, and/or an output image. In some embodiments, however, outputs of the neural network model 400 are obtained from a hidden layer 404-1 through 404-n in addition to, or in place of, output(s) from the output layer(s) 406.

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 404-1 through 404-n may share decisions relating to labeling, with no single layer making an independent decision as to labeling.

FIG. 4B depicts an example neuron 450 that corresponds to the neuron labeled as “1,1” in hidden layer 404-1 of FIG. 4A, according to one embodiment. Each of the inputs to the neuron 450 (e.g., the inputs in the input layer 402 in FIG. 4A) is weighted such that input a₁ through aₚ corresponds to weights w₁ through wₚ as determined during the training process of the neural network model 400.

In some embodiments, some inputs lack an explicit weight, or have a weight below a threshold. The weights are applied to a function a (labeled by a reference numeral 410), which may be a summation and may produce a value z₁ which is input to a function 420, labeled as f_{1,1}(z₁). The function 420 is any suitable linear or non-linear function. As depicted in FIG. 4B, the function 420 produces multiple outputs, which may be provided to neuron(s) of a subsequent layer, or used as an output of the neural network model 400. For example, the outputs may correspond to index values of a list of labels, or may be calculated values used as inputs to subsequent functions.

It should be appreciated that the structure and function of the neural network model 400 and the neuron 450 depicted are for illustration purposes only, and that other suitable configurations exist. For example, the output of any given neuron may depend not only on values determined by past neurons, but also on future neurons.

The neural network model 400 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. The neural network model 400 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics, and information. The machine learning programs may use deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing-either individually or in combination. The machine learning programs may also include natural language processing, semantic analysis, automatic reasoning, and/or machine learning.

Based upon these analyses, the neural network model 400 may learn how to identify characteristics and patterns that may then be applied to analyzing image data, model data, and/or other data. For example, the model 400 may learn to identify features in a series of data points.

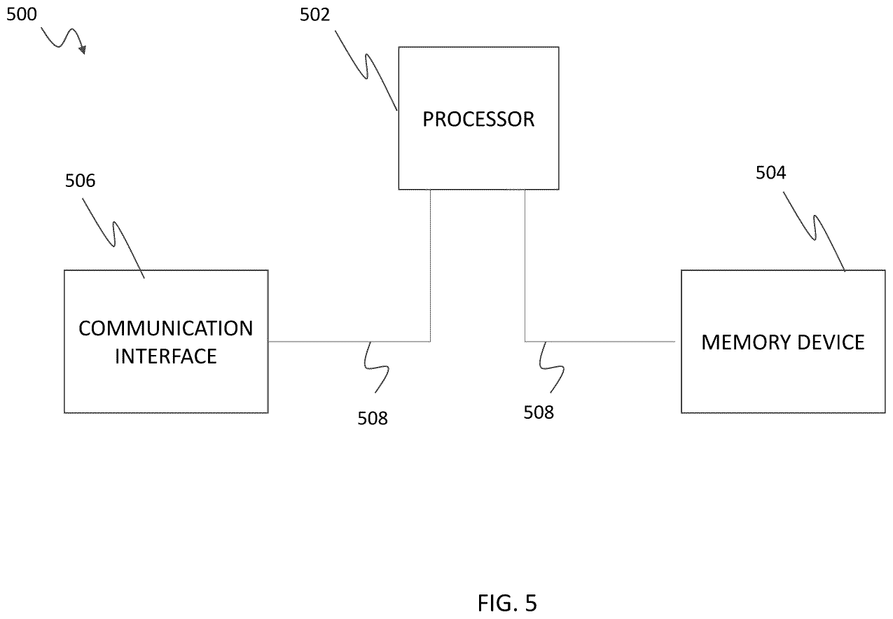

FIG. 5 is a block diagram of an example computing device 500. Autonomy computing system 200 or part of autonomy computing system 200 may be implemented with computing device 500. In the example embodiment, computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

### EXAMPLES

### Example 1

Multimodal sensor fusion is a capability needed for autonomous robots, enabling object detection and decision-making in the presence of failing or uncertain inputs. While recent fusion methods excel in normal environmental conditions, these approaches fail in adverse weather, e.g., heavy fog, snow, or obstructions due to soiling. A novel multi-sensor fusion approach tailored to adverse weather conditions is introduced. In addition to fusing RGB and LiDAR sensors, which are employed in recent autonomous driving literature, the sensor fusion stack described herein is also capable of learning from NIR gated camera and radar modalities to tackle low light and inclement weather.

Multimodal sensor data are fused through attentive, depth-based blending schemes, with learned refinement on the Bird's Eye View (BEV) plane to combine image and range features effectively. Detections are predicted by a transformer decoder that weighs modalities based on distance and visibility. The method described herein improves the reliability of multimodal sensor fusion in autonomous vehicles under challenging weather conditions, bridging the gap between ideal conditions and real-world edge cases. The approach improves average precision (AP) by 17.2 AP compared to the next best method for the vulnerable class of pedestrians in long distances and challenging foggy scenes. AP is a metric used to evaluate the performance of object detection in machine learning.

### 1. INTRODUCTION

Autonomous vehicles rely on multi-modal perception systems with sensors such as LiDAR, camera, and radar, combining distinct modalities with complementary strengths to enable safe autonomous driving. Recent work combines input from these diverse sensors to enhance environment perception with accurate localization and classification of objects in captured street scenes. As such, these systems benefit from the accuracy of LiDAR depth, the robustness of radar, and the dense semantic information of cameras. Although fusion is needed for downstream classification and localization tasks, when sensors fail, special care is required to achieve better results with fusion than with single camera networks. Examples of fusion strategies include physically-inspired entropy-driven fusion, and learned attention fusion. The most effective 3D object detection methods often utilize a Bird's-Eye-View (BEV) representation, either by concatenating modality-specific feature maps or by employing multiple attention-based modules to enhance BEV features. However, the robustness of these techniques is typically validated only on datasets collected under favorable weather conditions, and they have not been proven effective against adverse weather-related disturbances, such as asymmetric degradation in LiDAR point clouds. This vulnerability is largely attributed to the reliance on a unimodal query generator, and dependence on LiDAR-based depth projections, which may lead to network failures in the absence of reliable LiDAR data.

Gated imaging technology offer a promising alternative to conventional imaging modalities. Gated cameras may be used to actively eliminate backscatter, provide accurate depth, and achieve high SNRs in adverse scenarios such as night-time, fog, snowy or rainy conditions, all due to their active gated scene illumination. In the systems and methods described herein, gated cameras are used in addition to more conventional camera, LiDAR and radar data to further increase robustness.

In summary, the challenge of robust object detection in inclement weather is tackled by addressing two major problems in sensor fusion: modality projection quality and robustness against sensor distortions in adverse weather. To this end, a sensor-adaptive multi-modal fusion method (SAMFusion) is provided. In the systems and methods described herein, a novel encoder structure is implemented with a depth-guided camera-LiDAR transformation and additional early fusion for both camera modalities, incorporating distance-wise precise cross-modal projections. Additionally, a novel multi-modal, distance-based query generation approach is applied to avoid relying solely on the LiDAR modality to generate detection proposals. Specifically, the following contributions are made:
A novel transformer-based multi-modal sensor fusion approach is provided, improving object detection in the presence of severe sensor degradation.
An encoder architecture is provided, which combines early camera fusion, depth-based cross-modal transformation, and adaptive blending, in conjunction with learned distance-weighted multimodal decoder proposals to increase the reliability of object detection in various lighting and weather conditions.
A transformer decoder is provided, which aggregates multimodal information in the BEV through multimodal proposal initialization.
The method is validated on automotive adverse weather scenes and improves 3D-AP, especially for the pedestrian class by more than 17.2 AP in dense fog and 15.62 AP in heavy snow for the most challenging distance category from 50 m-80 m relative to the state of the art.

### 2. RELATED WORK

3D Object Detection. The task of 3D object detection evolved from 2D object detection, providing the prediction of 3D-bounding boxes (bboxes) and orientations of objects. Unimodal LiDAR methods have been explored to leverage the depth accuracy of the LiDAR sensor to predict 3D bboxes based on LiDAR point clouds. Point-based methods therefore generate detections from raw point cloud features. Other methods group LiDAR points into 3D voxels or pillars. Voxel and point-based methods may also be chained together, which implement additional refinement steps to improve 3D object detection performance based on region of interest pooling. Camera-based methods were investigated, which work in the image space itself. However, camera data has proven to be a good candidate for fusion with LiDAR, as the former may be mapped to a BEV representation, and the latter natively lives in the BEV space. Therefore, the camera representation space has since evolved from camera coordinates to joint multi-view setups and predicted BEV representations, improving 3D detection accuracy.

Multi-modal Sensor Fusion. While a common BEV map is not necessarily the default choice, several multi-modal sensor fusion approaches have incorporated semantic camera information to enrich individual LiDAR points. Subsequent studies have investigated how to extract detailed information from camera data for LiDAR point clouds, which is heavily dependent on the quality of projection and was further refined. These approaches introduced virtual 3D camera points to provide a denser environmental context for enhancing sparse point clouds at long distances. This approach was extended by integrating deformable attention to create a unified representation of both modalities in the 3D voxel space.

Operating in the BEV space may be applied. This approach fuses features that are aggregated in a reference frame (e.g., the LiDAR BEV perspective) and then processed by task decoders performing various perception tasks such as 3D object detection, lane estimation, tracking, semantic segmentation, and planning. Such a framework supports multitasking and multimodal models that benefit from the additional supervision and regularization provided by these configurations. However, even the most recent BEV representation approaches still face challenges in projecting detailed camera features into the BEV world coordinate system and preventing error propagation in the case of sensor distortions.

Sensor Fusion in Adverse Weather. Systems and methods described herein specifically aim to tackle the degradation of individual sensors under adverse weather conditions, which drastically reduces object detection performance as shown in known methods. Multi-modal sensor fusion emerged as a viable approach to achieve robustness under these scenarios. In detail, the camera modality is fused with radar information, or additional sensing modalities and novel, physically-grounded fusion techniques are used. However, these only allow for the prediction of 2D object detections. The approach described herein projects to a common BEV plane, with attention-based feature fusion and the incorporation of dense depth to allow for 3D object detection.

### 3. SAMFusion

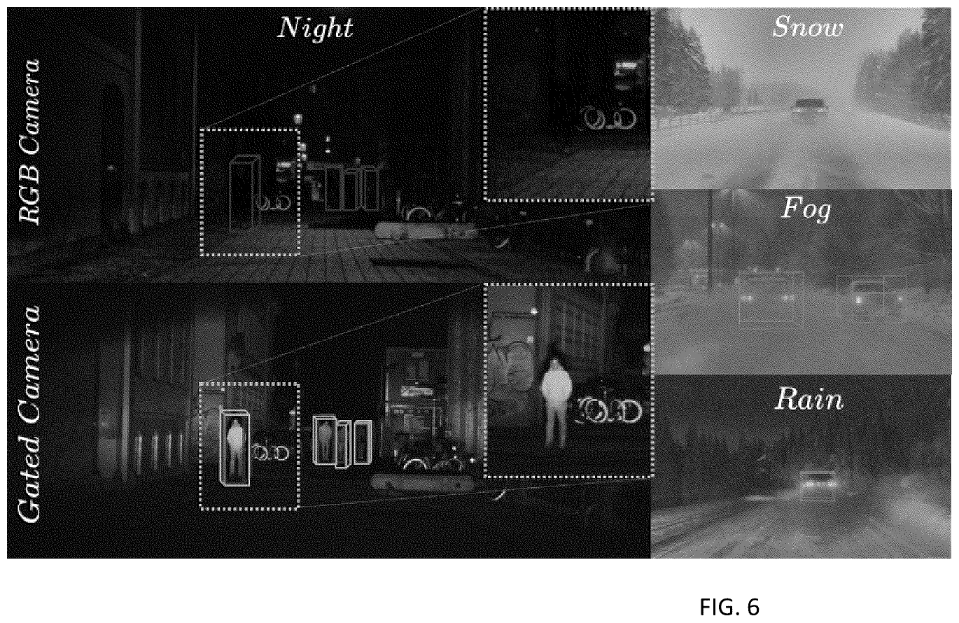

In this section, the SAMFusion architecture is provided for multimodal 3D object detection. SAMFusion leverages the complementary strengths of LiDAR, radar, RGB, and gated cameras (see FIG. 6). SAMFusion is a multimodal approach that combines gated near infrared (NIR), RGB color-imaging, light detection and ranging (LiDAR), and radio detection and ranging (radar) point clouds for object detection in adverse weather conditions, such as in night-time, snowy, raining, foggy, and/or rainy conditions. The qualitative results in FIG. 6 show beneficial low light detection capabilities from the gated camera as well as example detections from the approach described herein in night-time, snowy, rainy, and/or foggy conditions, which are achieved through attentive blending of features and multimodal querying. Ground truth bounding boxes are depicted in red, and predictions of bounding boxes are in green.

Gated cameras excel in foggy and low-light conditions, while radar is effective in rain and at long distances. By integrating these sensors into a depth-based feature transformation, a multi-modal query proposal network and a decoder head, SAMFusion ensures robust and reliable 3D object detection across diverse scenarios.

The architecture is illustrated in FIGS. 7A-7C. In FIG. 7A, features from each modality are extracted. In FIG. 7B, features are refined, with fusing modalities through attention and depth-based blending. In FIG. 7C, refined gated and range (LiDAR and radar) features are agglomerated in the bird's eye view (BEV), and are combined in a weighted manner that is aware of distance and weather, before being refined further and sent to detection heads to produce bounding box outputs. The gated camera and radar sensors complement the high-definition RGB camera and LiDAR to better handle poor illumination and adverse weather.

The inputs-RGB/gated camera, LiDAR, radar—are transformed into features through their respective feature extractors 701. These features are blended in the multi-modal encoder 704 in an attentive fashion, and are combined with camera-specific feature maps to produce enriched features 703 φ*-referred to as “early fusion”.

Features φ* are then passed to the multi-modal decoder proposal module 706 where they are refined with another level of fusion in the BEV representation to combine the image features (gated camera) and the range features (LiDAR, radar) in an adaptive, distance-weighted fashion for initial object proposals. Additionally, the enriched features φ* are sent to the transformer decoder 708 that refines the initial object proposals to attentively produce detection outputs. The decoder proposal module 706 includes optimizations to adaptively weigh distance through a learned weighting scheme that is aware of the physical properties of ranging sensors while fusing with the information-dense camera modality.

### 3.1 Cross-Modal Adaptive Blending

This section describes the early attention fusion schemes of individual sensor features. An illustration of the methodology is shown in FIG. 7B.

In the SAMFusion encoder, early attention fusion integrates information from different modalities. To achieve this, a weighted context is first created from the features of the primary modality, which aligns with the features of the secondary modality. This context (key) is then queried with data from the second modality (query), resulting in a rich mix of aligned features.

The early fusion approach described herein supports queries from camera and LiDAR modalities, creating two parallel instances of pair-wise (query, key) attentive fusion. In “Camera-Adaptive Blending,” queries from RGB and gated cameras are compared against weighted LiDAR context samples (RGB camera against sampled LiDAR and gated camera against sampled LiDAR). This blending accounts for objects visible in one modality but not in the other. Similarly, in “LiDAR-Adaptive Blending,” LiDAR queries are scored with sampled weighted camera context features blended across RGB and gated images (LiDAR against sampled camera).

Finally, radar features are refined in a similar fashion, where the radar proposals are scored with weighted context provided from the RGB camera.

Camera-Adaptive Blending. In this module, attention is used to score the camera features φ_{C}, φ_{G} (query) against the weighted context φ_{L,CG} (keys, values) derived from the LiDAR modality. To generate such a context, LiDAR BEV features 41 corresponding to the camera features are gathered. The LiDAR feature encoder outputs are available in the form of a BEV image. Therefore, all the camera pixels (u, v) are transformed onto the LiDAR coordinate frame. In order to achieve this, pixel-wise depth d(u, v) is needed for each camera feature coordinate. In FIG. 7B the concatenation is denoted with the symbol © that assigns the corresponding depth to each pixel.

Together with depth, camera intrinsics and extrinsics (with respect to LiDAR) are used to lift image points into the 3D (x, y, z) LiDAR coordinate space. Depth is computed differently for RGB and gated cameras. For RGB cameras, stereo RGB pairs from the dataset are used to predict depth, while for gated cameras, the depth (d_{MG}) is attained from a mono-RGB method, which is fine-tuned on the gated camera data.

The projection ψ_{C;G,L}, ψ_{C,L} for RGB camera and ψ_{G,L} for gated camera, is attained by lifting the pixels into a point cloud and then applying a change of frame of reference to bring the 3D points into the LiDAR coordinate frame. Pixels in the images may be lifted into a point cloud using:

$$\{ \begin{matrix}z = d ( u , v ) , \\ x = ( u - {C}_{x} ) \times z / {f}_{x} , \\ y = ( v - {C}_{y} ) \times z / {f}_{y} ,\end{matrix} \qquad ( 1 )$$

where (fx, fy) are the horizontal and vertical focal lengths of the camera and (Cx, Cy) is the pixel location corresponding to the camera center. As used herein, “C;G” denotes the variable may be for RGB cameras (C) or the gated camera (G), depending on for which of the two modalities, the RGB cameras or the gated camera, the computation is performed.

The reprojected 3D camera points (x, y, z) are then squashed along the height coordinate y onto the LiDAR BEV grid. Further, the discretization of the LiDAR feature map φ_{L}(x, z) is resolved by bilinear interpolation of the corresponding BEV coordinates. Subsequently, the found correspondences are used to enrich each 3D camera point (x, y, z) with extracted LiDAR features φ_{L} which are backprojected into the camera image and paired with image features prior to scoring with attention. Through this procedure, for each RGB and gated camera pixel φ_{C}(u, v) and φ_{G}(u, v), corresponding LiDAR feature points φ_{L,C}(u, v) and φ_{L,G}(u, v) are obtained.

Finally, these two independent weighted LiDAR contexts are blended together to get a composite representation φ_{L,CG} that is aware of both camera modalities. This composition is obtained by summing up the two feature maps, where the positional dependence in φ_{L,C}(u, v) and φ_{L,G}(u, v) is dropped for notational convenience:

$${φ}_{L , C G} = {φ}_{L , C} ⊕ {φ}_{L , G} \qquad ( 2 )$$

where ⊕ is the element-wise addition operation.

The described process is introduced to integrate detailed camera-specific information into φ_{L,CG}, avoiding the case when either modality fails due to reduced visibility of the sensors in adverse lighting conditions.

Having obtained the associated LiDAR feature points to compare with, cross-modal attention is integrated to learn enriched modality-specific feature maps, including object features from the LiDAR modality that may be occluded in the camera frames due to the physical position of the sensors. An attention computation is carried out between the respective camera and LiDAR modalities (φ_{C}, φ_{L,CG}) and (φ_{G}, φ_{L,CG}) to produce the final enriched camera-specific feature maps

$${φ}_{C}^{*} and {φ}_{G}^{*} ,$$

to guide the decoder object proposals. The cross-modal attentive blending equation is written with LiDAR (key, value) φ_{L,CG}, abbreviating the extracted RGB and gated features φ_{C}, φ_{G} as φ_{C;G} and the enriched maps

$${φ}_{C}^{*} , {φ}_{G}^{*} as {φ}_{C ; G}^{*} ,$$

### as Eqn. (3)

$${φ}_{C ; G}^{*} = {\sum }_{{φ}_{L , CG} ∈ {J}_{s}} softmax ( \frac{{φ}_{C ; G} {φ}_{L , CG}^{T}}{\sqrt{d}} ) {φ}_{L , CG} . \qquad ( 3 )$$

The attention computation is performed over a local window Jₛ around the sampled point (i, j), with a window size of k and a softmax normalization factor of d, representing the dimensionality of the point cloud features.

Besides the cross-modal attention mechanism, intra-modal-attention is executed in parallel on the queried modality, described by

$${φ}_{C ; G}^{*} = {\sum }_{{φ}_{C ; G} ∈ {J}_{s}} softmax ( \frac{{φ}_{C ; G} {φ}_{C ; G}^{T}}{\sqrt{d}} ) {φ}_{C ; G} . \qquad ( 4 )$$

Afterwards,

$${φ}_{C ; G}^{*}$$

feature maps are derived, where cross-modal-attention and intra-modal-attention results are fused with a learned weighting scheme (independently for RGB φ_{C} and gated φ_{G}).

LiDAR-Adaptive Blending. In this module, LiDAR features φ_{L} is blended with a weighted context from RGB and gated camera features φ_{CG,L} using attention, with LiDAR features serving as queries and camera features as keys and values. Unlike camera-adaptive blending, depth is inherently included in the LiDAR BEV features φ_{L}(x_{L}, z_{L}). Therefore, before projecting into the camera feature map, the LiDAR points (x_{L}, y_{L}, z_{L}) are assigned to columns at the respective feature map grid positions (x_{L}, z_{L}).

Furthermore, the 3D LiDAR features φ_{L}(x_{L}, y_{L}, z_{L}) are mapped onto the corresponding 2D image points (u_{C;G,L}, v_{C;G,L}) by projection, analogous to Eq. 1, through the ψ_{L,C;G} LIDAR-to-camera (RGB; gated) projection matrix. The camera features corresponding to relevant LiDAR feature coordinates (u_{C;G,L}, v_{C;G,L}) are acquired by sampling from the image modalities through bilinear interpolation.

Next, the LiDAR-aware sampled image features are blended from the two camera modalities:

$${φ}_{CG , L} = {φ}_{C , L} ⊕ {φ}_{G , L ,} \qquad ( 5 )$$

before scoring against corresponding LiDAR queries. As before, the positional dependence in φ_{C}(u_{C,L}, v_{C,L}), φ_{G}(u_{G,L}, v_{G,L}) is dropped for notational convenience.

The enriched LiDAR feature map

$${φ}_{L}^{*}$$

is obtained similarly to the camera-Adaptive-Blending described above, blending the output of the cross-modal attention between LiDAR queries and LiDAR aware image features (similarly to Eq. 3) to the output of the intra-modal attention over LiDAR features (as per Eq. 4).

Radar-Adaptive Blending. In the radar branch, the same principle as for the LiDAR-Adaptive Blending described above is relied on, with the only difference being that only the weighted context from the RGB camera modality is calculated and intra-modal attention is not performed due to the sparseness of radar point clouds.

### 3.2 Multi-Modal Decoder

SAMFusion generates initial object proposals Q_{MM} based on a multi-modal BEV feature map with an additional learned weighting scheme, prioritizing modalities based on distance and weather. The distance weighting is encoded in the BEV-based fusion of radar and LiDAR while additional weather robustness is gained by enriching the multimodal queries with the gated modality. An example is rainy weather, where LiDAR is compromised and may be enhanced by proposals from camera and radar modalities.

In particular Q_{MM} are generated from LiDAR, radar and gated camera features. An illustration of the methodology is presented in FIG. 7C.

Weighted Radar And LiDAR Feature Map Fusion. Distance-dependent sensor-specific ranging characteristics are used and a weighted fusion approach is employed to combine the enriched feature maps

$${φ}_{L}^{*} and {φ}_{R}^{*}$$

into a joint feature map φ_{LR} described by

$${φ}_{L R} = {Γ}_{MLP} ( f ( d , σ ) {φ}_{L}^{*} + ( 1 - f ( d , σ ) ) {φ}_{R}^{*} where f = exp ( {( - \frac{d}{2 {σ}^{2}} )}^{2} ) , \qquad ( 6 )$$

and d is the distance of each feature point from the ego vehicle and σ is a learned parameter.

The learned δ_{MLP} weighs LiDAR and radar features through a gaussian mask with learned variance, which amplifies LiDAR at close range and suppresses it at longer ranges to favor radar. The range is dependent on the learned gaussian variance. The resulting features φ_{LR} are thus modulated to contain LiDAR and radar, weighted by their relative importance across the ROI.

Late Gated Camera Features Fusion. To generate the final object proposal, the method encodes the initial proposals extracted from the gated camera. Due to the time-of-flight principle of the sensor, they encode distance within the captured intensity profiles. To encode detailed gated camera features

$${φ}_{G}^{*}$$

a pillar-based conditioning approach is used to transform the camera feature map into a common BEV representation matching the distance-weighted feature map φ_{LR}. The original LiDAR coordinates are transformed according to the 3D LiDAR points into the camera representation, as described in Sec. 3.1 and are used to sample camera features

$${φ}_{G}^{*} .$$

Then, the camera features are assigned to the corresponding LiDAR pillars, and the feature positions in the LiDAR BEV grid are determined through average pooling, resulting in a BEV camera feature map φ_{G,BEV}. Features φ_{G,BEV} and φ_{LR} are fused in an additive manner to obtain a distance-encoded weighted feature map φ_{fuse}, which is dependent on three modalities by conditioning the ranging sensor feature maps with corresponding gated camera features. Further, class-dependent convolution layers are applied onto φ_{fuse} to extract object proposal centers based on maximum intensity values and obtain the initial object proposals Q_{MM}. Q_{MM} sets the starting point for the decoder refinement process through Multi-Modal-Predictive-Interaction layers.

### 3.3 Training

The SAMFusion architecture, designed as a transformer network, is trained. It first matches labels to predictions using Hungarian loss, then minimizes a loss that includes a weighted sum for classification (Cross-Entropy), regression, and intersection over union (IoU).

### 3.4 Implementation

SAMFusion is implemented in PyTorch and the open-source library MMDe-tection3D. The camera branch is initialized with a ResNet-50 backbone and pretrained Cascade Mask R-CNN weights. The original RGB and gated camera images are scaled with center-based cropping to [800,400] to reduce computational cost. The voxels are defined to be 0.075 m deep, 0.075 m wide and 0.2 m high. The LiDAR and radar point clouds are restricted to (0 m, 100 m) in range and to (−40 m, 40 m) in width. The height range is set to (−3 m, 1 m) and (−0.2 m, 0.4 m) for LiDAR and radar respectively. Four stacked transformer decoder layers are implemented, guided by RGB, gated camera, and LiDAR modalities with 200 initial multi-modal proposals. All models are trained for 12 epochs in an end-to-end manner with a batch size of 4 on NVIDIA V100 GPUs.

### 4 EXPERIMENTS

In this section, experiments validating the design choices of SAMFusion are presented. Subsection 4.1 introduces the metrics and datasets, Subsection 4.2 presents variation of the individual contributions, and Subsection 4.3 shows comparisons against existing state-of-the-art uni- and multi-modal 3D detection methods on day, night, foggy and snowy scenarios.

### 4.1 Dataset And Evaluation Metrics

This section describes the evaluation of SAMFusion on the publicly available dataset named SeeingThroughFog, including 12,997 annotated samples in adverse weather conditions, covering night, fog, and snowy scenarios in Northern Europe. The dataset is divided into 10,046 samples for training, 1,000 for validation, and 1,941 for testing. The test split is further divided into 1,046 daytime and 895 nighttime samples, with respective weather splits.

Evaluation Metrics. Object detection performance is evaluated according to the metrics specified in the KITTI evaluation framework, including 3D-AP and BEV-AP for the passenger car and pedestrian class. 40 recall positions are incorporated for the AP calculation. To match the predictions and ground truth intersection is applied over union (IoU) with an IoU of 0.2 for passenger cars and 0.1 for pedestrians. Further, results are reported according to respective distance bins.

### 4.2 Variation Experiments

In this subsection, the methods are validated as shown in FIGS. 8A and 8B. In FIG. 8A, the number of modalities as input and in the proposal generation is varied. Adding sensor modalities improves pedestrian detection reliability, especially in low light conditions. Fusing both cameras in the adaptive blending module boosts overall detection quality of relatively small objects due to detailed, camera-specific feature maps with significant information content in far distances. In FIG. 8B, the proposal modality configurations and the depth-based transformations in the encoder and the learned Γ-weighting for LiDAR-radar-fusion are adjusted. Object detection results are evaluated based on the 3D AP metric explicitly for the pedestrian class and the most relevant far distance of 50-80 m.

Specifically, in FIG. 8A, varying numbers of input modalities is explored using the SAMFusion architecture. Configurations include single camera-LiDAR (CL), gated-LiDAR (GL), camera-LiDAR-radar (CLR), gated-LiDAR-radar (GLR), and camera-gated-LiDAR-radar (CLGR) inputs. These methods utilize queries based on LiDAR and radar data with learned distance weightings. The results are focused on the pedestrian class at extended distances, where detection is most challenging due to sparse LiDAR points. The outcomes underscore the benefits of integrating additional modalities, noticeable during both day and night conditions.

Performance comparisons between single camera modalities with passive RGB and active gated imaging (GL and CL) show distinct advantages under different lighting conditions. In daylight, the inclusion of RGB color information in CL provides a performance boost of 2.85 AP-points within the 50 m to 80 m range. Conversely, at night, the superior SNR of active illumination in GL enhances detection, yielding improvements of +1.08 AP in mid-range and +3.45 AP in long-range distances. Integrating both camera technologies in the CGL configuration leverages the strengths of both modalities, delivering enhanced performance across day and night settings. The addition of radar data further amplifies overall performance, although the absence of the gated camera slightly diminishes night-time efficacy.

The optimal results manifest when all four modalities (CGLR) are used, cap-italizing on the unique strengths of each sensor to enhance the architecture's resilience across diverse lighting and adverse weather conditions. This configuration also benefits from leveraging proposals generated from all involved modalities.

Further, in FIG. 8B, validation is extended to assess the impact of fusion techniques described herein beyond mere modality integration. The efficacy of depth-based transformations, weighted BEV maps, and various modal proposal strategies are investigated. The incremental inclusion of these methodological enhancements correlates with notable performance improvements, indicating that simply stacking modalities is insufficient for maximizing results. For instance, incorporating multi-modal proposals elevates night-time pedestrian detection by 15.2% over solely point cloud-based proposals. Additionally, distance-aware weighting mechanism, Γ_{MLP}, further boosts detection capabilities by up to 20.7%. Notably, proposals utilizing gated imaging data yield a larger improvement margin than those based on color data, due to their inherent distance encoding, which facilitates superior geometrical localization.

### 4.3 Assessment

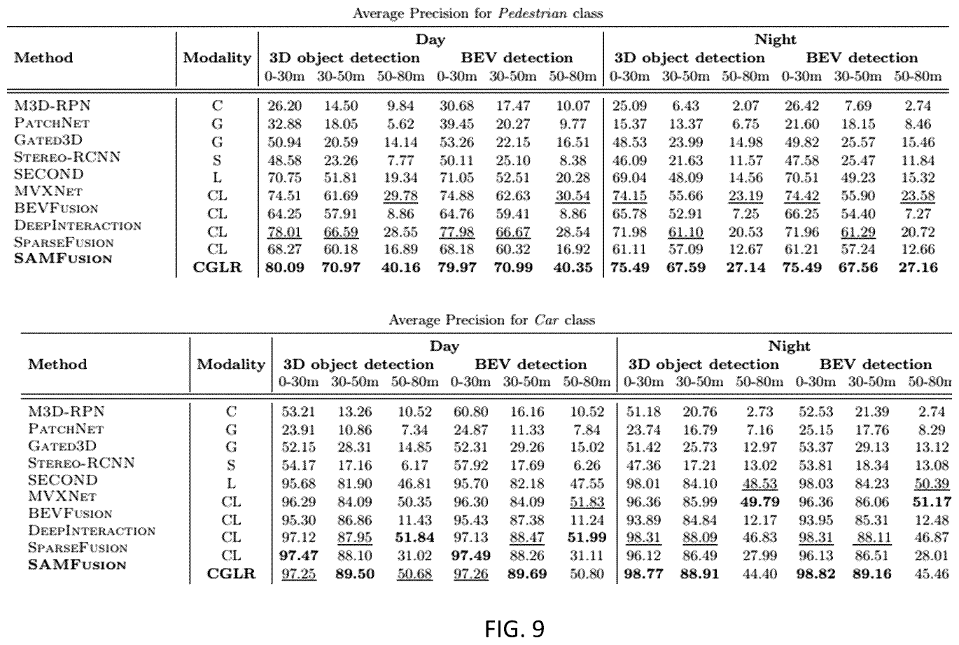

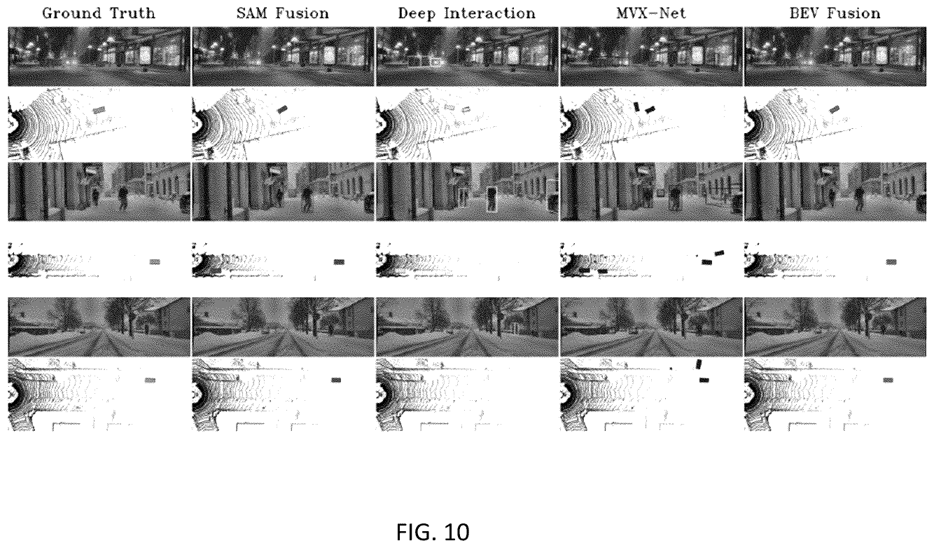

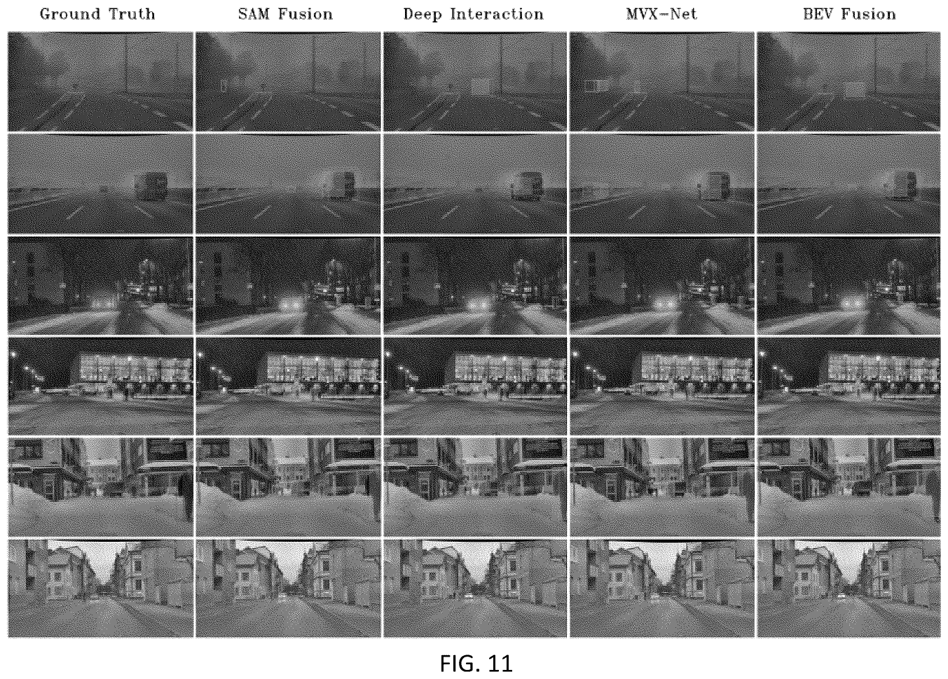

SAMFusion is compared against nine state-of-the-art methods, including one monocular camera 3D object detection method, two gated camera methods, one stereo camera approach, one LiDAR approach, and four LiDAR-RGB fusion methods. The results are summarized in FIG. 9 and further qualitative assessments are presented in FIGS. 10 and 11, with reported detections in both BEV and perspective view. As shown in FIG. 10, while all methods perform well in the daytime clear setting, SAMFusion outperforms other reference methods in adverse and low light conditions (rain, snow, fog, twilight, night). In rainy and snowy settings, other methods show missing (BEVFusion) or spurious (MVXNet, DeepInteraction) detections, especially for the pedestrian class. At twilight and night, performance of known methods is further worsened, with missing and erroneous detections in most objects. Moreover, SAMFusion excels with far-away objects and pedestrian detection. In FIG. 11, on the left the ground truth is illustrated with red bounding boxes, followed by the SAMFusion approach, BEVFusion, MVXNet and DeepInteraction.

SAMFusion outperforms all state-of-the-art multi-modal methods in pedestrian detection under adverse weather and varying lighting conditions. Particularly in the far distance range of 50 m to 80 m, SAMFusion achieves margins of up to 34.85% during the day and 17.03% during the night for 3D pedestrian detection. Additionally, pedestrian detection performance improves in mid-range distances by 10.6%. These improvements may be attributed to the enhanced visibility at night arising from additional active sensors, but also to their effective incorporation through a multi-modal distance-based weighting scheme.

Car detection improves slightly. This is due to labeling bias in the car category for 3D annotations, which prioritize precision over completeness. Objects with fewer than five LiDAR points were marked as “don't care”, making it difficult to measure improvements in such challenging cases. For pedestrians, a different strategy focusing on completeness was employed, thereby providing a greater amount of challenging ground truth labels not available for the car category.

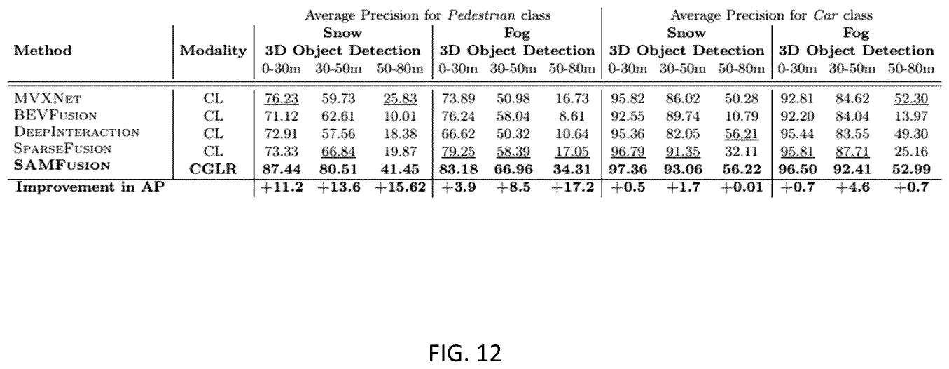

Adverse Weather Evaluation. FIG. 12 shows improved performance of the method described herein in adverse weather, like snow and fog. SAMFusion achieves significant performance increases as shown in the last two rows of the table. State of the art LiDAR-RGB methods struggle with reduced visibility and back-scatter in adverse weather, causing such fusion approaches to perform significantly worse than in clear conditions, despite the relatively simple scene configurations. Relative to these baselines, SAMFusion achieves improvements of up to 13.6 AP (20.4% relative) for pedestrians at midrange and 15.62 AP (60.51% relative) at long-range compared to the second-best (LiDAR and RGB) method in snowy scenes. In foggy scenes SAMFusion achieves high margins of up to 17.2 AP (101.2% relative) for pedestrians. For the car class in foggy conditions, it achieves improvements of up to 4.6 AP (5.2% relative).

Detection performance in adverse weather correlates with scene difficulty. The relative improvement in performance compared to FIG. 9 may be explained by the reduced number of road users in these weather splits simplifying the general task at hand as less people participate in road traffic.

### 5. CONCLUSION

SAMFusion, a multi-modal adaptive sensor fusion method for robust 3D object detection in adverse weather for autonomous driving, is provided. The approach described herein enhances the conventional camera-LiDAR perception stack with gated camera and radar sensors, significantly improving performance in low-light and adverse weather scenarios, particularly for detecting narrow-profiled and vulnerable road users. SAMFusion employs depth-based adaptive blending of sensing modalities in conjunction with a learned multi-modal, distance-weighted decoder-query mechanism that leverages sensor-specific visibility over distance. The method described herein is validated on the challenging SeeingThroughFog dataset, achieving an improvement of 17.2 AP points for pedestrians in dense fog and 15.62 AP points in heavy snow at long range. Additional tasks may be incorporated, such as planning and propagating uncertainty in adverse weather for improved decision-making and trajectory planning, further enhancing the robustness and effectiveness of autonomous driving systems in challenging conditions.

An example technical effect of the methods, systems, and apparatus described herein includes at least one of: (a) 3D fusion of features from multiple modalities by representing features in BEV, (b) enriched features of one modality with features of at least one other modality, (c) fusion with attention, (d) fusion with cross-modal attention and/or intra model attention, (e) enriched features of one modality with composite paired features from two modalities, (f) providing initial proposals for a transformer decoder in detecting object proposals based on enriched features from two or more modalities, (g) providing initial proposals based on a fused feature map that include distance weighting, or (h) use of a gated camera to increase robustness in object detection.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable/machine-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomy computing system of an autonomous vehicle for object detection by the autonomous vehicle in adverse environmental conditions, the autonomy computing system comprising at least one processor in communication with at least one memory device, and the at least one processor programmed to:
receive sensor data of an environment in which the autonomous vehicle is operating, the sensor data detected from one or more sensors of a plurality of modalities, the plurality of modalities including a first modality and a second modality, the sensor data including first sensor data from one or more sensors of the first modality and second sensor data from one or more sensors of the second modality, the second sensor data being in a bird's eye view (BEV);
extract first features in the environment based on the first sensor data and second features in the environment based on the second sensor data;
fuse, in the BEV, the first features and the second features into first enriched features of the first modality and second enriched features of the second modality by:
representing the first features in the BEV to derive first BEV features, based on depth information of the first features;
fusing the first features with the second features corresponding to the first BEV features to derive the first enriched features; and
fusing the second features with the first features corresponding to the second features to derive the second enriched features;
detect object proposals based on the first enriched features and the second enriched features;
predict objects in the environment based on the object proposals; and
control operation of the autonomous vehicle based on predicted objects.

2. The autonomy computing system of claim 1, wherein the at least one processor is further programmed to:
fuse the first features and the second features by:
integrating cross-modal attention between the first modality and the second modality in fusion.

3. The autonomy computing system of claim 2, wherein the at least one processor is further programmed to:
fuse the first features and the second features by
integrating intra-modal attention of at least one of the first modality or the second modality in the fusion.

4. The autonomy computing system of claim 1, wherein the at least one processor is further programmed to:
detect the object proposals by:
generating initial object proposals based on the first enriched features and the second enriched features; and
detecting, using a transformer decoder, the object proposals in the first enriched features and the second enriched features based on the initial object proposals.

5. The autonomy computing system of claim 4, wherein the plurality of modalities further include a third modality, the sensor data including third sensor data from one or more sensors of the third modality, the at least one processor further programmed to:
extract third features based on the third sensor data;
fuse the first features, the second features, and the third features into the first enriched features, the second enriched features, and third enriched features;
represent the first enriched features in the BEV to derive first BEV enriched features;
fuse the first BEV enriched features, the second enriched features, and the third enriched features into a fused feature map; and
compute the initial object proposals based on the fused feature map.

6. The autonomy computing system of claim 5, wherein the second modality has a different range from the third modality, the at least one processor further programmed to:
fuse the first enriched features, the second enriched features, and the third enriched features by:
combining the second enriched features weighted by a first weighting and the third enriched features weighted by a second weighting, the first weighting and the second weighting being dependent on a distance of a feature point from the autonomous vehicle.

7. The autonomy computing system of claim 1, wherein the plurality of modalities include a first camera modality and a second camera modality, the at least one processor further programmed to:
extract first camera features based on sensor data from one or more sensors of the first camera modality, and second camera features based on sensor data from one or more sensors of the second camera modality;
blend the second features corresponding to first BEV camera features and the second features corresponding to second BEV camera features to derive composite paired second features, the first BEV camera features being the first camera features represented in the BEV, the second BEV camera features being the second camera features represented in the BEV;
fuse the composite paired second features with the first camera features to derive first enriched camera features; and
fuse the composite paired second features with the second camera features to derive second enriched camera features.

8. The autonomy computing system of claim 1, wherein the plurality of modalities include a first camera modality and a second camera modality, the at least one processor further programmed to:
extract first camera features based on sensor data from one or more sensors of the first camera modality;
extract second camera features based on sensor data from one or more sensors of the second camera modality;
blend the first camera features corresponding to the second features and the second camera features corresponding to the second features to derive composite paired camera features; and
fuse the second features with the composite paired camera features to derive the second enriched features.

9. The autonomy computing system of claim 1, wherein the plurality of modalities include three or more modalities.

10. The autonomy computing system of claim 1, wherein the plurality of modalities include a gated camera.

11. The autonomy computing system of claim 1, wherein the plurality of modalities include radio detection and ranging (radar).

12. A method for object detection by an autonomous vehicle in adverse environmental conditions, the method comprising:
receiving sensor data of an environment in which the autonomous vehicle is operating, the sensor data detected from one or more sensors of a plurality of modalities, the plurality of modalities including a first modality and a second modality, the sensor data including first sensor data from one or more sensors of the first modality and second sensor data from one or more sensors of the second modality, the second sensor data being in a bird's eye view (BEV);
extracting first features in the environment based on the first sensor data and second features in the environment based on the second sensor data;
fusing, in the BEV, the first features and the second features into first enriched features of the first modality and second enriched features of the second modality by:
representing the first features in the BEV to derive first BEV features, based on depth information of the first features;
fusing the first features with the second features corresponding to the first BEV features to derive the first enriched features; and
fusing the second features with the first features corresponding to the second features to derive the second enriched features;
detecting object proposals based on the first enriched features and the second enriched features;
predicting objects in the environment based on the object proposals; and
controlling operation of the autonomous vehicle based on predicted objects.

13. The method of claim 12, wherein fusing the first features and the second features further comprises:
integrating cross-modal attention between the first modality and the second modality in fusion.

14. The method of claim 13, wherein fusing the first features and the second features further comprises:
integrating intra-modal attention of at least one of the first modality or the second modality in the fusion.

15. The method of claim 12, wherein detecting the object proposals further comprises:
generating initial object proposals based on the first enriched features and the second enriched features; and
detecting, using a transformer decoder, the object proposals in the first enriched features and the second enriched features based on the initial object proposals.

16. The method of claim 15, wherein the plurality of modalities further include a third modality, the sensor data including third sensor data from one or more sensors of the third modality, the method further comprising:
extracting third features based on the third sensor data;
fusing the first features, the second features, and the third features into the first enriched features, the second enriched features, and third enriched features;
representing the first enriched features in the BEV to derive first BEV enriched features;
fusing the first BEV enriched features, the second enriched features, and the third enriched features into a fused feature map; and
computing the initial object proposals based on the fused feature map.

17. The method of claim 16, wherein the second modality has a different range from the third modality, fusing the first enriched features, the second enriched features, and the third enriched features further comprising:
combining the second enriched features weighted by a first weighting and the third enriched features weighted by a second weighting, the first weighting and the second weighting being dependent on a distance of a feature point from the autonomous vehicle.

18. The method of claim 12, wherein the plurality of modalities include a first camera modality and a second camera modality, the method further comprising:
extracting first camera features based on sensor data from one or more sensors of the first camera modality;
extracting second camera features based on sensor data from one or more sensors of the second camera modality;
blending the second features corresponding to first BEV camera features and the second features corresponding to second BEV camera features to derive composite paired second features, the first BEV camera features being the first camera features represented in the BEV, the second BEV camera features being the second camera features represented in the BEV;
fusing the composite paired second features with the first camera features to derive first enriched camera features; and
fusing the composite paired second features with the second camera features to derive second enriched camera features.

19. The method of claim 12, wherein the plurality of modalities include three or more modalities.

20. The method of claim 12, wherein the plurality of modalities include a gated camera.
